(19) United States
(12) Patent Application Publication
(10) Pub. No.: US 2018/0370219 A1
(43) Pub. Date: Dec. 27, 2018

(54) PRINT STATION WITH A SCREEN FRAME ELEVATION MECHANISM AND SCREEN PRINTING MACHINE THEREOF

(71) Applicant: KTK LDA, Abade - Barcelos (PT)

(72) Inventors: Joaquim MATOS FERREIRA, São Mamede Infesta (PT); Antonio PEREIRA DA SILVA, Abade - Barcelos (PT)

(21) Appl. No.: 16/063,462

(22) PCT Filed: Dec. 19, 2016
(86) PCT No.: PCT/IB2016/057788

§ 371 Date: Jun. 18, 2018

(30) Foreign Application Priority Data
Dec. 18, 2015 (PT) 109042
May 27, 2016 (EP) 16171756.6

(51) Int. Cl. B41F 15/08; B41F 15/36

(52) U.S. Cl. CPC B41F 15/0863; B41F 15/36

(57) ABSTRACT

Print station (1) for a screen printing machine, said print station (1) having a screen frame (14) and a print base (8) for receiving a product (10, 10A) to be screen printed through said screen print frame (14), said print station (1) comprising a screen frame elevation mechanism comprising a first shaft (6) and wherein the screen frame (14) is rotatable about said first shaft (6), wherein said first shaft (6) is movable between a first and a second position, such that the screen frame (14) is translationally moveable relative to the print base (8) when the screen frame (14) is in a printing position relative to the print base (8), further comprising a rotatable circular-section second shaft (5), wherein the first shaft (6) is solidly fixed to the second shaft (5) and the first shaft rotation axis is offset from the second shaft rotation axis. Also, a method of operating the print station (1) for a screen printing machine, comprising: lowering, or raising, the screen frame (14) into, or from, a printing position relative to the print base (8) by simultaneously rotating the screen frame (14) about said first shaft (6) and also moving said first shaft (6) such that the screen frame (14) moves translationally relative to the print base (8).

### TECHNICAL FIELD

The present disclosure relates to a print station elevation mechanism for screen printing machines, and a screen printing machine including said mechanism, namely for textile products, in particular for flatbed screen printing.

### BACKGROUND

Screen printing is a printing process comprising the use of a mesh screen to transfer ink onto an object, but only on the areas made permeable to the ink on a stencil screen. Screen printing is also known as silk-screen, serigraphy and serigraph printing.

Usually, a blade or ramped surface is moved across the screen to fill the open mesh apertures with ink, and an inverse movement causes the screen to touch the object along a contact line. This causes the ink to touch and adhere to the object through the mesh apertures, as the screen springs back after the blade has passed.

Normally, one colour is printed at a time, so usually several screens are used to produce a multicoloured image or design.

Thus, it is rather important to have a mechanism for lowering said screen onto the object to be printed and also, after printing, for raising said screen from the object.

There exist several machine models with different elevation mechanisms used in a printing station; each machine model allows installation of one to several printing stations disposed in circular, oval or linear positions around the machine main body.

Prior art machines also relate to radial screen printing machines, in particular for textile application, machine that is provided with printing stations.

In all machine models existing in the market the objective is to apply product, either ink or other material, in articles and to create a decoration on the article. The product application on the article is implemented by a screen printing process using a screen frame, and such screen containing the pattern or shape to be applied. Each printing station applies the product by screen printing process on the article, each article may get various products types, each station can apply only one product or several at same time, depending on the printing station technology.

The existing machines on the market perform the process described above in different ways and using different elevation mechanisms on printing stations with disadvantages compared to the present disclosure. These disadvantages of existing elevation mechanisms are discussed below.

3D printing, see FIGS. 2A 2B, is defined as the successive application of product layers by the screen printing process with product intermediate drying before applying the next layer, forming a decorative figure with several layers 12 printed on top of each layer until is defined a 3D figure on article. There is no limit of layers applications, greater the number of layers the 3D motif shape becomes more visible on the article. Thus when applied several layer of product on the article, the figure pattern becomes taller defined by number of overlapped layers 12 and define the 3D shape figure.

However, the existing machines on the market which have elevation mechanisms on printing workstation in reference to the printing base, reveal a problem relating to the lack of definition after applying several successive layers 12 illustrated in FIG. 2C. After several layer printing applications the 3D shape gets successively shifted in reference to supporting printing base, and the greater the number of layers, the more visible is this defect.

Another issue is the article contamination problem that occurs during the elevation movement M1 from the screen printing frame 14 in relation to the printing base 8. The article contamination problem illustrated in FIGS. 3A, 3B and 3C, happens due the suction process 15 created by the elevation movement M1 made by the screen printing frame 14 in reference to the printing base 8. The elevation movement M1 creates a suction area 15 forcing the article 10A bending over the product printed on the article 16, the article touch the printed area and cause contamination with the printed product. This problem typically occurs in fixed printing base machines as known in the prior art. The article contamination defect does not happen in a systematic way in all parts in the printing process. During the printing process, it can happen randomly to any of several placed parts in the print bases, making it difficult to control or mitigate manually or using specific mechanisms.

Document DE10344022A1 discloses a print station having a mechanism that enables simultaneous rotation and translation of the printing screen, but the mechanism is complex and encumbers all sides of the print station and thus prevents easy frontal access of the print station, which is very important for introducing and removing the products to be printed and maintenance activities. Furthermore, the column hoists do not provide easily multipliable forces, have comparatively higher wear and are costly for precision highly-repeatable movements.

Document U.S. Pat. No. 4,907,506 discloses a print station having a mechanism that enables rotation and translation of the printing screen, but not in use of the print station, as is clear from slot 102 receiving a knob 112 which by loosening is able to move along said slot 102 such that a arm 106 may be moved—and fixed—at any of various positions. The print station of U.S. Pat. No. 4,907,506 is not translationally moveable relative to the print base when the screen frame is in a printing position.

These facts are disclosed in order to illustrate the technical problem addressed by the present disclosure.

### GENERAL DESCRIPTION

The present disclosure relates to a print station elevation mechanism for screen printing machines and a screen printing machine thereof.

The disclosure includes an automatic mechanism comprising an elevation translational movement mechanism between an initial position and working position applied to printing stations on screen printing machines, hereby mentioned as elevation/rotation automatic mechanism.

This mechanism is also able to provide a translational movement moving the printing station arm supporting the screen printing frame in reference to a printing base. The translational movement can be obtained by the substantially simultaneous movement driven by actuators, moving the screen printing frame from an initial position to a working position whereby the screen printing frame is translationally movable between initial position and working position. The movement is reversible.

Alternatively, a different movement can be obtained by the subsequent movement driven by actuators, i.e. moving the printing station screen printing frame from an initial position to a working position, by shifting the rotation shaft followed by rotating the screen frame about said shaft, or the reverse, such that the end result is the same as if the screen printing frame had translationally moved between a first and a second position.

The substantially simultaneous—or subsequent—movement driven by actuators is obtained by including an electronic data processor for controlling said actuators and configured to drive substantially simultaneously—or subsequently—said actuators.

The present disclosure also relates to a radial screen printing machine, in particular for textile application, machine that is provided with printing stations comprising the disclosed elevation/rotation automatic mechanism.

This disclosure solves at least two problems on existing machines. It eliminates an offset problem during the process of producing 3D printing by screen printing multiple layers, and also eliminates the problem of article contamination due to suction, particularly on articles exceeding the print base. The disclosure provides namely these advantages while ensuring a very high precision in terms of print screen placement relative to the print base and the product to be printed.

The present disclosure also relates to a process of transfer printing ink or other textile processes in screen printing machines, comprising the disclosed print station elevation movement in reference to the printing base.

It is disclosed a print station for a screen printing machine, said print station having a screen frame and a print base for receiving a product to be screen printed through said screen print frame, said print station comprising a screen frame elevation mechanism comprising a circular-section first shaft and wherein the screen frame is rotatable about said first shaft, characterized in that said first shaft is movable between a first and a second position, such that the screen frame is translationally moveable relative to the print base when the screen frame is in a printing position relative to the print base;
comprising further a rotatable circular-section second shaft, wherein the first shaft is solidly fixed to the second shaft and the first shaft rotation axis is offset from the second shaft rotation axis.

The print station according to the disclosure is able to move translationally moveable relative to the print base when the screen frame is in a printing position, thus solving a first problem of lack of printing definition and avoiding successively shifts in reference to supporting printing base when printing successive layers.

Also, because the print station according to the disclosure is able to move translationally moveable relative to the print base when the screen frame is in a printing position, it is also solved the problem of article contamination that occurs during the elevation movement of the screen printing frame in relation to the printing base, because the elevation movement no longer creates a concentrated suction area.

Furthermore, the combination of the two offset shafts is an accurate low-wear robust mechanism, a mechanism which has a highly repeatable movement, with an easily multipliable binary, while also enabling a front opening for unencumbered frontal access opening of the print station. The binary is easily multipliable by a gear and/or lever combination enabling the use of smaller actuators.

In an embodiment, the screen frame is movable relative to the print base in two movement sections, a first movement section wherein the screen frame is rotationally movable relative to the print base and a second movement section wherein the screen frame is translationally moveable relative to the print base.

In an embodiment, the first shaft comprises two separate shaft parts located at opposite ends of the second shaft.

An embodiment comprises an actuator and an arm radially coupled to the second shaft such that the second shaft is rotatable about itself by said actuator.

In an embodiment, the first shaft is located at a first end of the screen frame and the print station comprises an actuator coupled to a second end of the screen frame such that the screen frame is rotatable about said first shaft by said actuator.

In an embodiment, the actuator is a linear actuator and is coupled to the screen frame through a rod.

In an embodiment, the print station is a flatbed screen print station.

In an embodiment, the actuator or actuators are pneumatic, electric or hydraulic.

In an embodiment, the print base and screen frame project from a print station main body.

It is also disclosed a screen printing machine comprises a plurality of print stations according to any one of the disclosed embodiments.

In an embodiment, the print bases are interchangeable between print stations such that a specific product laid on a print base may be printed through multiple screen frames.

In an embodiment, the printing stations are arranged in a circular, oval or linear layout.

It is also disclosed a method of operating the print station for a screen printing machine, according to any of the previous claims, comprising: lowering, or raising, the screen frame into, or from, a printing position relative to the print base by rotating the screen frame about said first shaft and also simultaneously moving said shaft such that the frame moves translationally relative to the print base. The simultaneous screen frame rotation and shaft movement does not need to be necessarily simultaneous with absolute precision: it can be substantially simultaneous, as necessary for obtaining the looked-for effects of the translational movement of the screen frame relative to the print base.

In an embodiment, the method comprises moving the screen frame relative to the print base in two movement sections, wherein a first movement section comprises moving the screen frame rotationally relative to the print base and a second movement section comprises moving the screen frame translationally relative to the print base.

### BRIEF DESCRIPTION OF THE DRAWINGS

The following figures provide schematic representations of preferred embodiments for illustrating the description and should not be seen as limiting the scope of invention.

FIG. 1A corresponds generally to a side view of the printing station in an initial position.

FIG. 1B corresponds generally to a side view of the printing station in a working position.

FIG. 1C generally corresponds to the actual application of illustration 1A in a real machine prototype.

FIG. 1D generally corresponds to the actual implementation of illustration 1B a real machine prototype.

FIG. 1E illustrates a first shaft 6 and a rotatable M3 second shaft 5, wherein the first shaft is solidly fixed to the second shaft and the rotation axis about the first shaft 6 is offset from the second shaft 5 rotation axis, such that said first shaft 6 is translationally movable M1 between a first and a second position, in this case with the first shaft 6 in a first position.

FIG. 1F corresponds to FIG. 1E with the first shaft 6 in a second position.

FIGS. 2A, 2B and 2C show the invention advantages and how it solves specific problems:

FIG. 2A corresponds to print base top view 7, supporting article to print 10 and printed decorative motif 11.

FIG. 2B illustrates perfect printing 3D operation, with layers alignment and with no offset 12 on printed decorative motif.

FIG. 2C illustrates printed layers forming offset 12 after several printing operations. This offset is produced with existing elevation mechanism in the market.

FIGS. 3A, 3B and 3C illustrate the advantage of avoiding product contamination.

FIG. 3A corresponds to print base top view 8 supporting article to print 10 and printed decorative motif 11. The article is dimensional larger them printing base 8, and part of article will fallen outside the print base 10A.

FIG. 3B corresponds to a printing station 1 in working position, screen printing frame 14 in printing position. The article 10 and 10A disposed on the print base ready to receive the decorative motif by screen printing process. The article is dimensional larger them printing base 8, then of the article 10A is fallen outside the print base 8.

FIG. 3C printing station 1 on initial (raised) position, with the screen printing frame 14 in the initial (raised) position. During the elevation process M1 vacuum zone is formed between the serigraphic or screen printing frame 14 and the fallen article 10A. Is generated a vacuum area 15 forcing the fallen article move to top 16 of the decorative motif 11, causing the article contamination defect 17 outside the printable area.

### DETAILED DESCRIPTION

It is disclosed an automatic mechanism comprising an elevation translational movement mechanism between an initial position and working position applied to printing stations on screen printing machines.

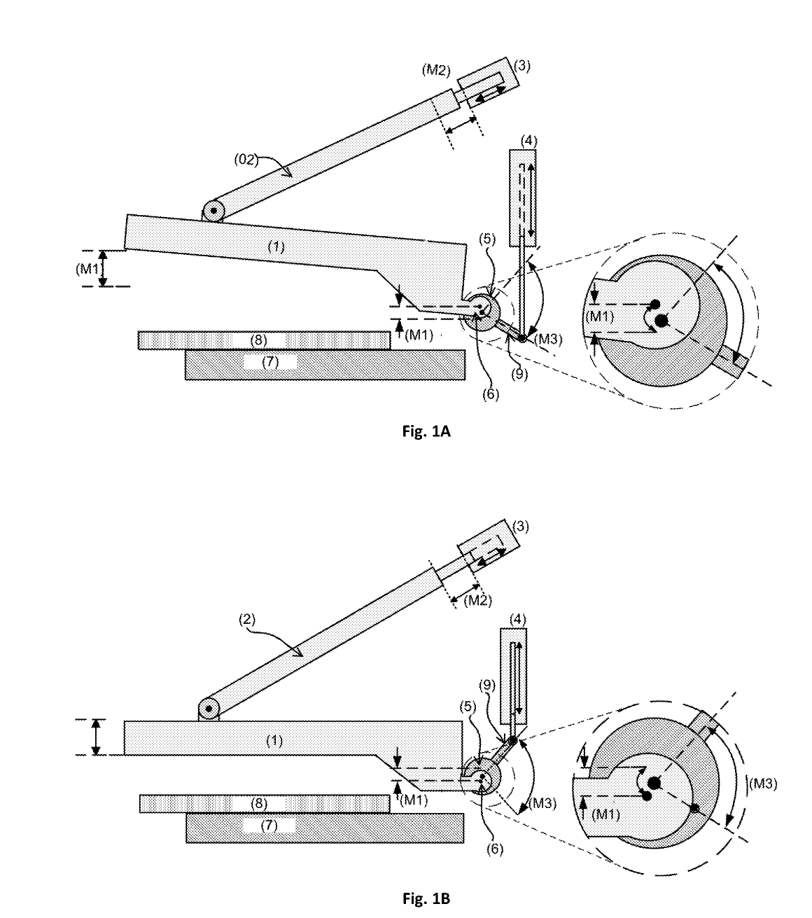

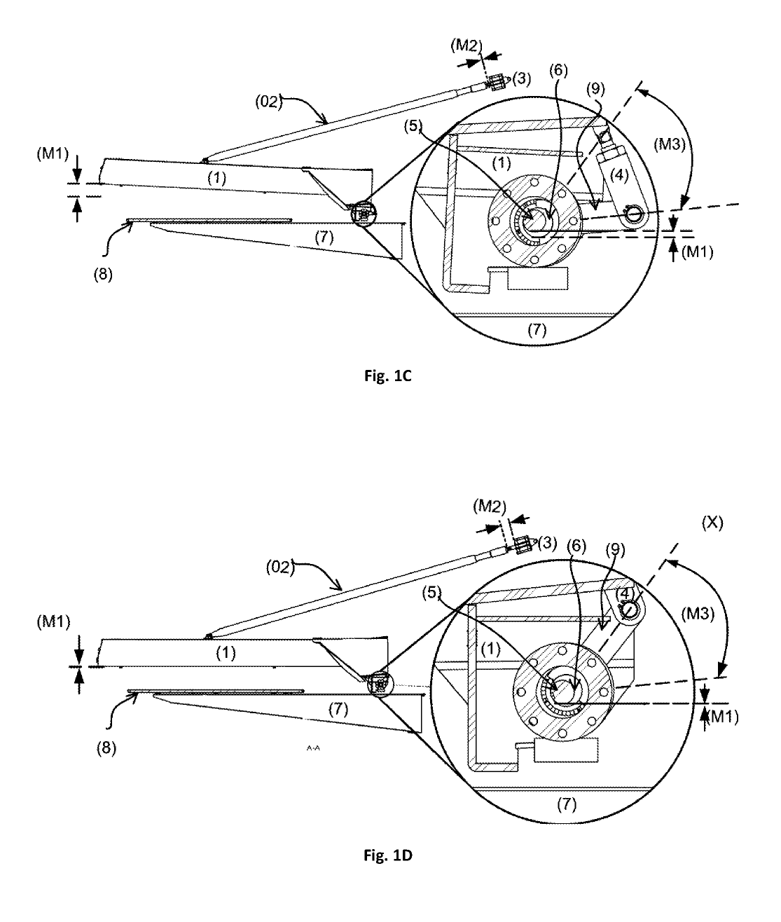

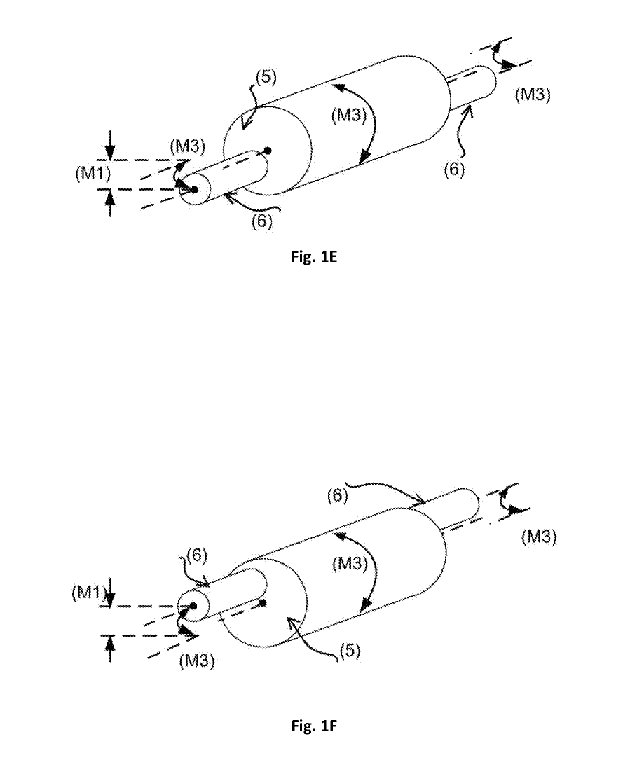

The disclosed mechanism defines a translational movement M1 moving the screen printing frame 14, in this cause fixedly joined with a printing station arm 1, in reference to printing base 8. The movement M1, is defined by the substantially simultaneous, or subsequent, movement M2 and M3 driven by actuators 3 and 4, move the printing station arm 1 from an initial position, shown in FIG. 1A, to the working position, shown in FIG. 1B, and it is to be noted that movement M1 can be made alternately in both directions.

The present disclosure also relates to a radial screen printing machine, in particular for textile application, machine that is provided with printing stations comprising the elevation/rotation automatic mechanism disclosed in the present invention.

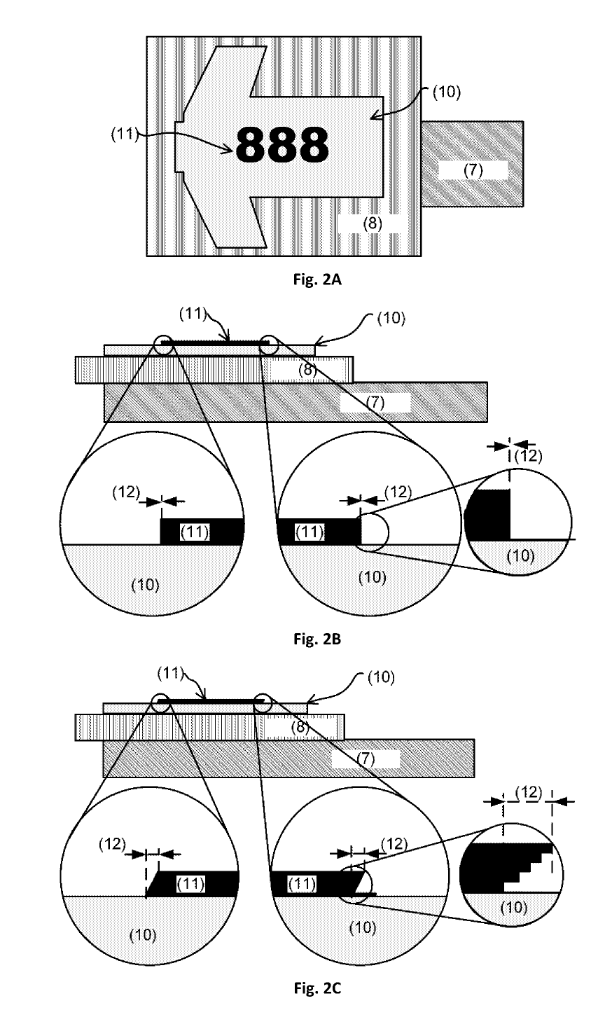

The disclosure namely solves two problems on existing machines at market. Eliminates the offset problem 12 during the process of producing 3D printing (FIGS. 2A, 2B and 2C), and eliminates the problem of article contamination due suction 10A to decorative motif on articles exceeding the print base 8 (FIG. 1A, 1B, 1C).

The present disclosure also relates to a process of transferring printing ink, or other textile processes, in screen printing machines, using the disclosed print station elevation movement process in reference to a printing base.

The present disclosure includes a elevation mechanism, defined by translation movement M1 between the initial position 1A and working position 1B. The elevation mechanism is implemented to printing stations (1, 7, 8, 13, 14) used in screen printing machines. The elevation mechanisms defines the movement M1, and allows printing station arm movement between initial position and working position without a supporting shaft related to printing machine main body. The prior art shaft is replaced by an eccentric mechanism comprising two collinear off-centred shafts 5 and 6. The eccentric mechanism allows application in all types of screen printing machines available in the market.

The eccentric mechanism allows the elimination the offset problem 12 during the process of producing 3D printing jobs (FIGS. 2a, 2B and 2C).

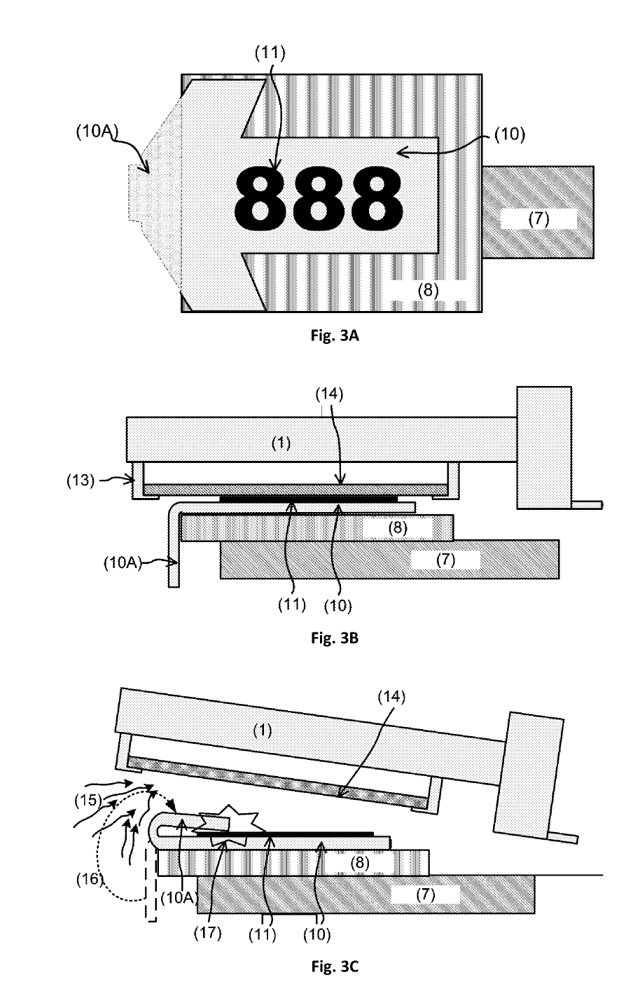

The eccentric mechanism also eliminates the article contamination problem due article suction 10A preventing the article bending to the top of the decorative motif (FIG. 3A, 3B, 3C).

The present invention mechanism contains, a printing station arm 1 integrated in a screen printing machine, a print base 8 fixed to a base support 7, said printing station arm being is attached to the printing machine main body by eccentric mechanism 5, 6. Depending on application, the screen printing machines allows the possibility to install one or several print stations with no maximum limit.

The printing station arm 1 is connected to actuator 3 by means of an arm 2 and fixed to machine main body by an eccentric mechanism formed by the parts 5, 6.

The present disclosure also relates to an automatic mechanism defined by elevation translational movement M1 between the initial position 1A and working position 1B applied to printing stations 1 on screen printing machines.

The mechanism defines a translational movement M1 moving the screen printing frame 14 in reference to the printing base 8. The movement M1 can be defined by its substantially simultaneous, or subsequent, movement M2 and M3 driven by actuators 3 and 4, moving the screen printing frame 14, translationally, from its initial position, shown in FIG. 1A, to the working position, shown in FIG. 1B, and it is to be noted that movement M1 can be made alternately in both directions.

The present disclosure also relates to a radial screen printing machine, in particular for textile application, machine that is provided with printing stations comprising the elevation/rotation automatic mechanism disclosed in the present invention.

The actuator 3 moves the screen printing frame, fixedly joined with a print station arm 1, through a linear actuator movement M2, between the initial position 1A and working position 1B, about a shaft 6.

The actuator 4 moves the lever 9 through a linear motion forcing the eccentric mechanism center 6 to move through the linear movement M1 of the shaft 6 from the initial position 1A to the working position 1B. In fact, the M1 movement is not strictly linear according to the illustrated embodiments, nor is it necessarily so or necessarily not so, but the movement is such to allow a translational movement of the shaft 6 between the two mentioned positions.

The actuators 3 and 4 can be actuated simultaneously by the electronic actuator, but individual activation is also possible when simultaneous movement is not required or necessary, for example for subsequent movements, i.e. staggered so that they do not occur at the same time.

The print station arm 1 itself does not have a fixed axis of rotation, such in the actuator arm 2 or on eccentric mechanism 5, 6. The printing station arm 1 is prepared to define movement M1 between two positions, initial position 1B and working position 1A.

The term “comprising” whenever used in this document is intended to indicate the presence of stated features, integers, steps, components, but not to preclude the presence or addition of one or more other features, integers, steps, components or groups thereof.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

The disclosure should not be seen in any way restricted to the embodiments described and a person with ordinary skill in the art will foresee many possibilities to modifications thereof.

The above described embodiments are combinable. The following claims further set out particular embodiments of the disclosure.

1. A print station for a screen printing machine, the print station comprising:
a screen frame;
a print base for receiving a product to be screen printed through the screen frame,
a screen frame elevation mechanism comprising a circular-section first shaft, wherein the screen frame is rotatable about the first shaft and
wherein the first shaft is movable between a first and a second position such that the screen frame is translationally moveable relative to the print base when the screen frame is in a printing position relative to the print base,
a rotatable circular-section second shaft, wherein the first shaft is solidly fixed to the second shaft and the first shaft rotation axis is offset from the second shaft rotation axis
such that the first shaft is translationally moveable by rotation of the second-shaft.

2. The print station according to claim 1, wherein the screen frame is movable relative to the print base in two movement sections, a first movement section having the screen frame rotationally movable relative to the print base and a second movement section having the screen frame translationally moveable relative to the print base.

3. The print station according to claim 1, wherein the first shaft comprises two separate shaft parts located at opposite ends of the second shaft.

4. The print station according to claim 1, comprising an actuator and an arm radially coupled to the second shaft such that the second shaft is rotatable about itself by the actuator.

5. The print station according to claim 1, wherein the first shaft is located at a first end of the screen frame and the print station comprises an actuator coupled to a second end of the screen frame such that the screen frame is rotatable about the first shaft by the actuator.

6. The print station according to claim 5, wherein the actuator is a linear actuator and is coupled to the screen frame through a rod.

7. The print station according to claim 1, wherein the print station is a flatbed screen print station.

8. Print station according to claim 1, wherein the actuator or actuators are pneumatic, electric or hydraulic.

9. The print station according to claim 1, wherein the print base and screen frame project from a print station main body.

10. The screen printing machine according to claim 1, further comprising a plurality of print stations.

11. the screen printing machine according to claim 10, wherein the print bases of the respective print stations are interchangeable between print stations such that a specific product laid on a print base may be printed through multiple screen frames.

12. The screen printing machine according to claim 11, wherein the printing stations are arranged in a circular, oval or linear layout.

13. A method of operating a print station for a screen printing machine, comprising:
lowering or raising a screen frame into or from, a printing position relative to a print base by rotating the screen frame about a first shaft and, substantially simultaneously, also translationally moving the first shaft such that the screen frame moves translationally relative to the print base.

14. The method according to claim 13, further comprising the step of moving the screen frame relative to the print base in two movements, wherein a first movement comprises moving the screen frame rotationally relative to the print base and a second movement comprises moving the screen frame translationally relative to the print base.

15. The method according to claim 14, further comprising the step of translationally moving the first shaft by rotating the second shaft.
